(19) United States
(12) Patent Application Publication
(10) Pub. No.: US 2014/0206285 A1
(43) Pub. Date: Jul. 24, 2014

(54) SYSTEMS AND METHODS FOR ESTABLISHING IN-BAND CONNECTIONS USING OUT-OF-BAND CONNECTIONS

(71) Applicant: BROADCOM CORPORATION, Irvine, CA (US)

(72) Inventors: Jithu JANCE, Bangalore, IN (US); Neeraj Kumar Garg, Bangalore, IN (US)

(73) Assignee: Broadcom Corporation, Irvine, CA (US)

(21) Appl. No.: 13/745,669

(22) Filed: Jan. 18, 2013

(51) Int. Cl. H04W 4/00

(52) U.S. Cl. CPC H04W 4/008
USPC 455/41.2; 455/39

(57) ABSTRACT

Systems and methods for establishing an in-band connection using an out-of-band connection are provided. In some aspects, a system includes a handshake module configured to communicate, by a first electronic device with a second electronic device, connection setup information over a first connection. The system also includes a security module configured to select a security scheme based on the communicated connection setup information. The system also includes a role module configured to determine a communication role of the first electronic device and a communication role of the second electronic device based on the communicated connection setup information. The system also includes a connection module configured to facilitate establishing a second connection between the first electronic device and the second electronic device based on the selected security scheme, the communication role of the first electronic device, and the communication role of the second electronic device.

### FIELD

The subject technology generally relates to establishing connections and, in particular, relates to systems and methods for establishing in-band connections using out-of-band connections.

### BACKGROUND

Two electronic devices may engage in a handshake with one another to establish a connection between them that can be used for the communication of data. The handshake may involve a process of negotiation that sets parameters for the connection before normal communication over the connection begins. Handshaking, for example, can be used to negotiate parameters that are acceptable to equipment and systems at both ends of the connection, including, but not limited to, information transfer rate, coding alphabet, parity, interrupt procedure, and other protocol or hardware features. However, depending on the type of connection to be established, handshaking can sometimes be a long and complex process that may delay the establishment of the connection.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1A illustrates an example of electronic devices having an in-band connection between one another.

FIG. 1B illustrates an example of electronic devices using an out-of-band connection to establish an in-band connection, in accordance with various aspects of the subject technology.

FIG. 2 illustrates an example of a system for establishing an in-band connection using an out-of-band connection, in accordance with various aspects of the subject technology.

FIG. 3 illustrates an example of a method for establishing an in-band connection using an out-of-band connection, in accordance with various aspects of the subject technology.

FIG. 4 illustrates an example of a method for selecting a security scheme, in accordance with various aspects of the subject technology.

FIG. 5 conceptually illustrates an electronic system with which any implementations of the subject technology are implemented.

### DETAILED DESCRIPTION

In the following detailed description, numerous specific details are set forth to provide a full understanding of the subject technology. It will be apparent, however, that the subject technology may be practiced without some of these specific details. In other instances, structures and techniques have not been shown in detail so as not to obscure the subject technology.

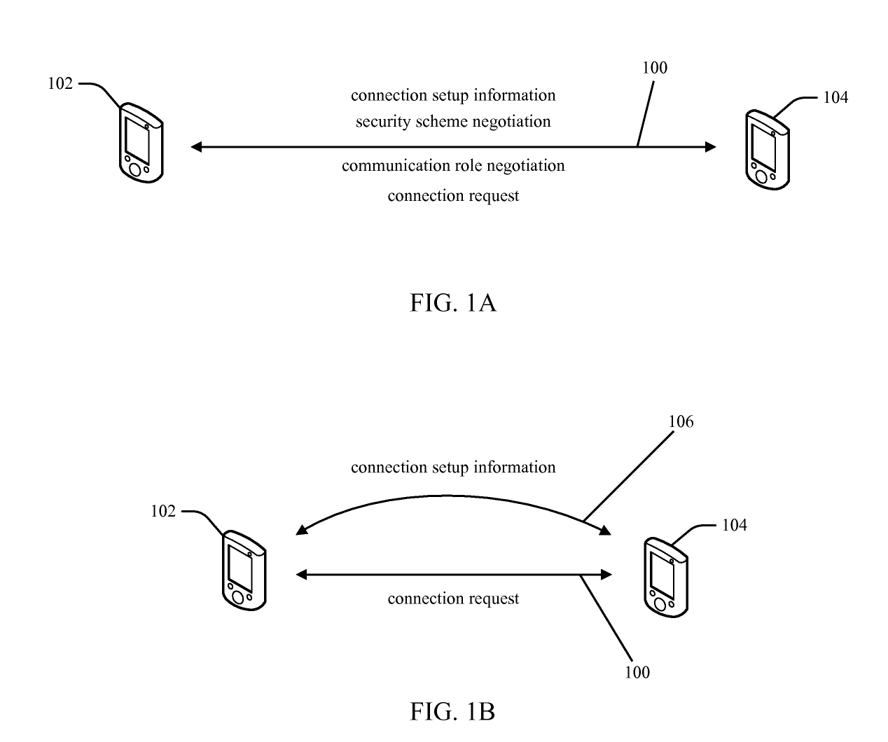

FIG. 1A illustrates an example of electronic devices 102 and 104 having in-band connection 100 between one another. Electronic devices 102 and 104 are illustrated in FIG. 1A as smartphones. However, electronic devices 102 and 104 may each be any device that transmits signals over a network, including, but not limited to, a desktop computer, a laptop computer, a tablet computer, a server, a switch, a router, a base station, a receiver, a personal digital assistant (PDA), a portable gaming device, and a printer. Electronic devices 102 and 104 may use in-band connection 100 to communicate with one another (e.g., as peers) without the use of a third device operating as an access point that establishes in-band connection 100 for electronic devices 102 and 104. In-band connection 100, for example, may be a Wi-Fi direct connection or any other wired or wireless connection that allows electronic devices 102 and 104 to communicate with one another. According to certain aspects, each of electronic devices 102 and 104 may play a particular role in the communication. For example, one of these electronic devices may operate as group owner, which provides functionality similar to an access point, while the other of the electronic devices may operate as a client, which may operate to join the group owner to establish in-band connection 100.

In order to establish in-band connection 100, electronic devices 102 and 104 may first engage in a handshake. Such a handshake may involve electronic devices 102 and 104 discovering one another (e.g., performing Wi-Fi direct discovery, which can take 2-4 seconds), communicating connection setup information with one another (e.g., to determine what services each device supports, such as performing Wi-Fi service discovery, which can take 2-4 seconds), negotiating a security scheme to connect to one another (e.g., performing Wi-Fi direct provision discovery to select a personal identification number (PIN) scheme or a push-button scheme to authenticate in-band connection 100, which can take 0.5-1 second), implementing the security scheme based on user input (e.g., having a user enter a PIN for the PIN scheme or push a button for the push-button scheme), negotiating communication roles with one another (e.g., implementing a Wi-Fi direct group owner negotiation protocol, which can take 1-3 seconds), scanning a plurality of channels between one another (e.g., implementing a Wi-Fi direct scan for establishing in-band connection 100, which can take 1-3 seconds), sending or receiving a connection request (e.g., a join operation), and/or other steps to establish in-band connection 100. This handshake, particularly for Wi-Fi direct connections, may be a complex and time-consuming process, which can ultimately delay the establishment of in-band connection 100.

According to various aspects of the subject technology, systems and methods are provided for implementing a handshake using an out-of-band connection to establish an in-band connection (e.g., in-band connection 100). Depending on the type of the out-of-band connection, implementing a handshake using the out-of-band connection may be less complex, faster, and/or more secure than (or equally as secure as) implementing a handshake using the in-band connection. Thus, systems and methods are provided for quickly establishing an in-band connection using an out-of-band connection.

FIG. 1B illustrates an example of electronic devices 102 and 104 using out-of-band connection 106 to establish in-band connection 100, in accordance with various aspects of the subject technology. In particular, electronic devices 102 and 104 may engage in a handshake using out-of-band connection 106 to establish in-band connection 100. Out-of-band connection 106, for example, may be a near-field communication (NFC) connection, a Wi-Fi proximity connection, and/or any other connection that enables a less complex, faster, and/or more secure (or equally secure) handshake than one implemented using in-band connection 100.

According to certain aspects, the handshake may involve electronic devices 102 and 104 detecting one another (e.g., using NFC instead of performing Wi-Fi direct device discovery), communicating connection setup information between one another (e.g., to determine what services each device supports), selecting a security scheme based on the communicated setup information (e.g., without negotiating with one another as in performing Wi-Fi direct provision discovery), determining the communication roles of one another (e.g., without negotiating with one another as in the group owner negotiation protocol implemented under Wi-Fi direct), and/or selecting an operating channel of in-band connection 100 (e.g., thereby avoiding the scanning of a plurality of channels as implemented under a Wi-Fi direct scan). The handshake using out-of-band connection 106 involves less steps and less negotiation than the handshake using in-band connection 100. Furthermore, since out-of-band connection 106 is an NFC connection with a short range (e.g., several centimeters to 1-2 meters), sharing connection setup information (e.g., handshake parameters) over such a short range is much faster. Thus, implementing a handshake using out-of-band connection 106 may be faster than implementing a handshake using in-band connection 100. For example, the handshake using out-of-band connection 106 may take 1-1.5 seconds to complete, while the handshake using in-band connection 100 may take 8-12 seconds to complete. Furthermore, passwords, PINs, shared keys, and/or other sensitive information may be communicated between electronic devices 102 and 104 in a secure manner since the range of NFC may be short.

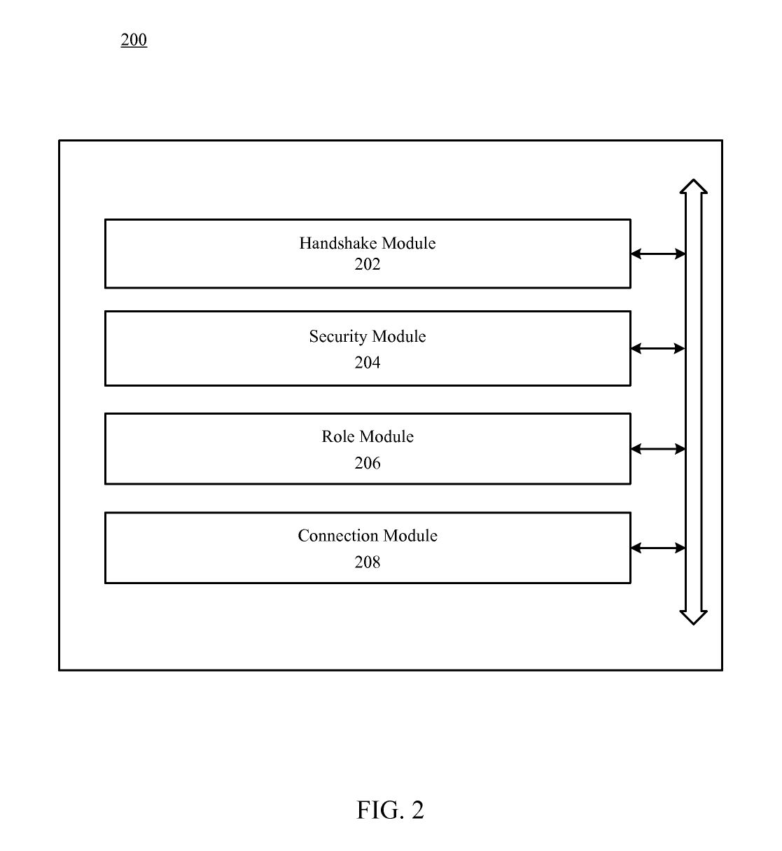

FIG. 2 illustrates an example of system 200 for establishing in-band connection 100 using out-of-band connection 106, in accordance with various aspects of the subject technology. System 200 includes handshake module 202, security module 204, role module 206, and connection module 208. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure. According to certain aspects, electronic device 102 and/or 104 may include system 200.

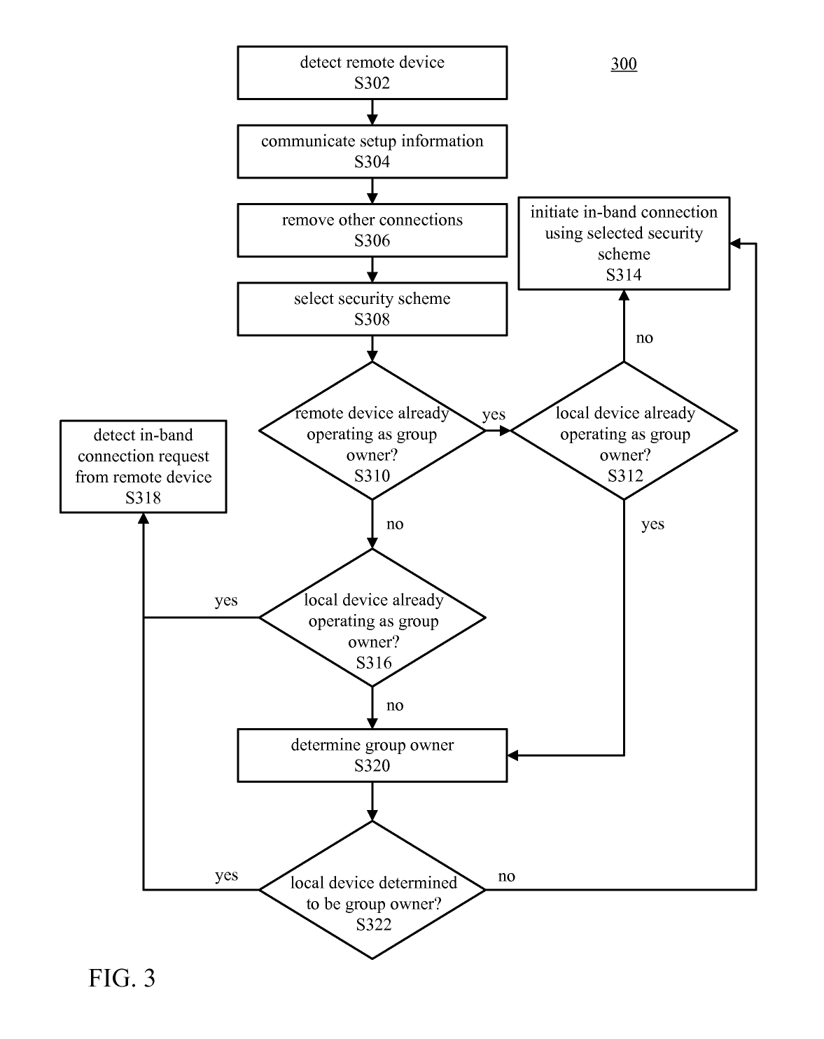

FIG. 3 illustrates an example of method 300 for establishing in-band connection 100 using out-of-band connection 106, in accordance with various aspects of the subject technology. System 200 in FIG. 2, for example, may be used to implement method 300. However, method 300 may also be implemented by systems having other configurations. Although method 300 is described herein with reference to the examples of FIGS. 1B, 2, 4, and 5, method 300 is not limited to these examples.

For the purposes of illustration, method 300 is described from the perspective of electronic device 102 establishing in-band connection 100 with electronic device 104. In this regard, electronic device 102 may be considered a local device that includes system 200 for implementing method 300, while electronic device 104 may be considered a remote device. However, it is understood that electronic device 104 may also include system 200 to implement method 300.

According to method 300, handshake module 202 of electronic device 102 detects electronic device 104 (e.g., the remote device) (S302). Since out-of-band connection 106 is an NFC connection, handshake module 202 may detect electronic device 104 when electronic device 104 is positioned within the vicinity of electronic device 102 (e.g., within several centimeters to 1-2 meters of electronic device 102). In response to the detection, handshake module 202 communicates connection setup information with electronic device 104 over out-of-band connection 106 (S304). In some aspects, handshake module 202 may receive the connection setup information from electronic device 104 and/or transmit the connection setup information to electronic device 104.

The connection setup information may include any information that can be used for establishing in-band connection 100 between electronic devices 102 and 104. In some aspects, the connection setup information includes an address of electronic device 102 and/or 104 (e.g., a p2p device address), the communication role of electronic device 102 and/or 104 (e.g., either group owner or client), a status of electronic device 102 and/or 104 (e.g., whether the electronic device has started any peer-to-peer communication, whether the electronic device is already operating as a client, whether the electronic device is already operating as group owner, a Concurrent_STA state (if applicable for Wi-Fi direct), etc.), a security scheme supported by electronic device 102 and/or 104 (e.g., a security scheme for authenticating in-band connection 100 such as a push-button scheme or a PIN-scheme for Wi-Fi direct), power source information of electronic device 102 and/or 104 (e.g., whether the electronic device is powered by battery or outlet, how much power is available to the electronic device, etc.), wireless capability information of electronic device 102 and/or 104 (e.g., Wi-Fi station (STA), standalone Wi-Fi direct, SoftAP, single channel concurrent support, multichannel concurrent support, etc.), enforced frequency information of electronic device 102 and/or 104 (e.g., standalone Wi-Fi direct, multi-channel concurrency, SoftAP, single channel with no STA connected, etc.), a service supported by electronic device 102 and/or 104 (e.g., universal plug and play, Bonjour, etc.), an identification of electronic device 102 and/or 104 (e.g., SoftAP_SSID), an intent value of electronic device 102 and/or 104 to become group owner, channel information, a password (e.g., SoftAP_Passphrase), a random-generated PIN, a shared key, and one or more concurrency flags.

According to certain aspects, handshake module 202 removes other existing connections that electronic device 102 may currently be engaged in (e.g., as a client) (S306). In some aspects, security module 204 of electronic device 102 selects a security scheme based on the communicated connection setup information (S308). The security scheme may be used to authenticate in-band connection 100. For example, the security scheme may be a push-button scheme (e.g., involving the push of a button on both electronic devices 102 and 104 to authenticate in-band connection 100), a predetermined PIN scheme (e.g., involving the sharing of a predetermined PIN between electronic devices 102 and 104), a randomly-generated PIN scheme (e.g., involving the sharing of a randomly-generated PIN between electronic devices 102 and 104), and/or another security scheme for authenticating in-band connection 100. In some aspects, the predetermined PIN and/or randomly generated PIN may be shared using out-of-band connection 106 as part of the connection setup information.

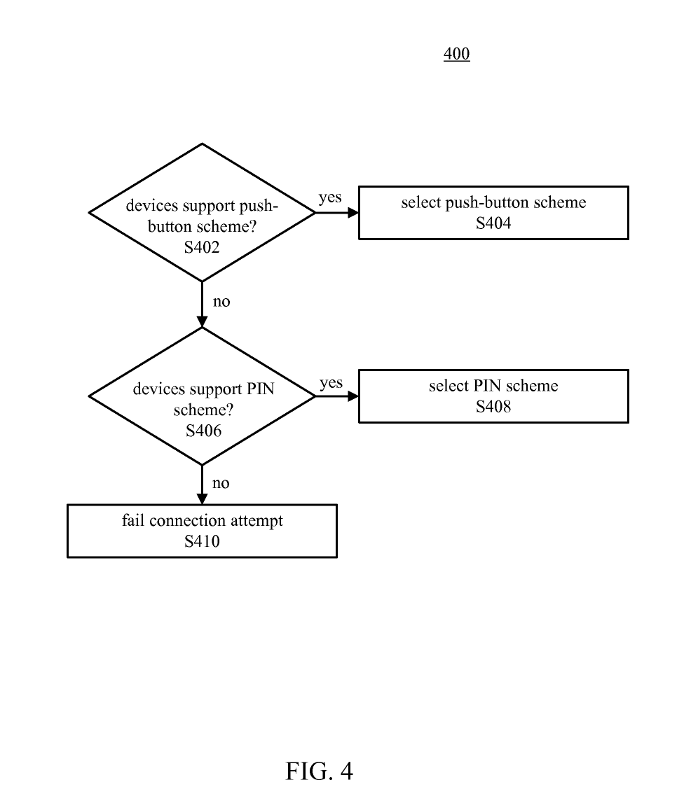

According to certain aspects, security module 204 may select the security scheme by determining what security scheme is supported by both electronic devices 102 and 104 using the communicated connection setup information. FIG. 4 illustrates an example of method 400 that security module 204 may implement to select a security scheme, in accordance with various aspects of the subject technology. According to method 400, security module 204 determines whether electronic devices 102 and 104 support the push-button scheme (S402). If so, then security module 204 selects the push-button scheme as the security scheme (S404). If not, then security module 204 determines whether electronic devices 102 and 104 support the PIN scheme (S406). If so, then security module 204 selects the PIN scheme as the security scheme (S408). If not, then security module 204 fails the attempt to establish in-band connection 100 with electronic device 104 (e.g., because of a failure to authenticate) (S410). Although method 400 provides one approach to selecting the security scheme, it is understood that other approaches for selecting the security scheme may be used. For example, electronic devices 102 and 104 may rely on the randomly generated PIN shared with one another as an additional or as an alternative security scheme to authenticate in-band connection 100.

Returning to FIG. 3, after a security scheme is selected, role module 206 of electronic device 102 determines the communication roles of electronic devices 102 and 104 based on the communicated connection setup information. In one or more implementations, role module 206 determines whether electronic devices 102 and 104 are already operating as group owners using the status information that is part of the communicated connection setup information. In some aspects, role module 206 determines whether electronic device 104 (e.g., the remote device) is already operating as group owner (S310). If so, then role module 206 determines whether electronic device 102 (e.g., the local device) is also already operating as group owner (S312).

If electronic device 102 is not already operating as group owner, then connection module 208 of electronic device 102 may initiate in-band connection 100 using the selected security scheme (S314). In such a scenario, electronic device 102 may operate as a client since electronic device 104 is already operating as group owner. Thus, connection module 208 may transmit a connection request (e.g., a join operation) to electronic device 104 to establish in-band connection 100 using the selected security scheme.

However, if role module 206 determines that electronic device 102 is already operating as group owner in S312 (e.g., both electronic devices 102 and 104 are already operating as group owner at this point), then role module 206 determines the group owner by selecting either electronic device 102 or 104 to be group owner (S320). According to certain aspects, role module 206 may make the selection based on different criteria. In one or more implementations, role module 206 may select the electronic device having an affirmative intent value (e.g., from the communicated connection setup information) to become group owner. In some aspects, role module 206 may make the selection based on the power source information (e.g., from the communicated connection setup information). For example, since being group owner may involve the use of more power compared to being a client (e.g., to perform additional processing), role module 206 may select the electronic device that is not powered by battery to be group owner (e.g., a device powered via a power outlet). In some aspects, role module 206 may select the electronic device with more battery power to be group owner. In the event of a tie (e.g., both electronic devices 102 and 104 have an affirmative intent value to be group owner, or both electronic devices 102 and 104 have the same power), role module 206 may select the electronic device with the lower address (e.g., MAC address value) to be group owner. Thus, if both electronic devices 102 and 104 are already operating as group owner, role module 206 may select only one of them to be group owner.

Returning to S310, if electronic device 104 is not already operating as group owner, then role module 206 determines if electronic device 102 is already operating as group owner (S316). If so, then electronic device 104 may operate as a client (since electronic device 102 is already operating as group owner). Thus, connection module 208 may help establish in-band connection 100 by detecting for any connection request (e.g., a join operation) from electronic device 104 to establish in-band connection 100 (S318).

However, if role module 206 determines that electronic device 102 is not already operating as group owner in S316 (e.g., both electronic devices 102 and 104 are not already operating as group owner at this point), then role module 206 determines the group owner by selecting either electronic device 102 or 104 to be group owner as discussed above with respect to S320. According to certain aspects, if electronic device 102 is selected to be group owner (S322), then connection module 208 may make electronic device 102 group owner (e.g., by starting an autonomous group owner operation) and then detect for any connection request (e.g., a join operation) from electronic device 104 to establish in-band connection 100 as discussed above with respect to S318. If, however, electronic device 102 is not selected to be group owner (S322), then connection module 208 may wait a predetermined period of time for electronic device 104 to become group owner and then initiate in-band connection 100 as discussed above with respect to 5314.

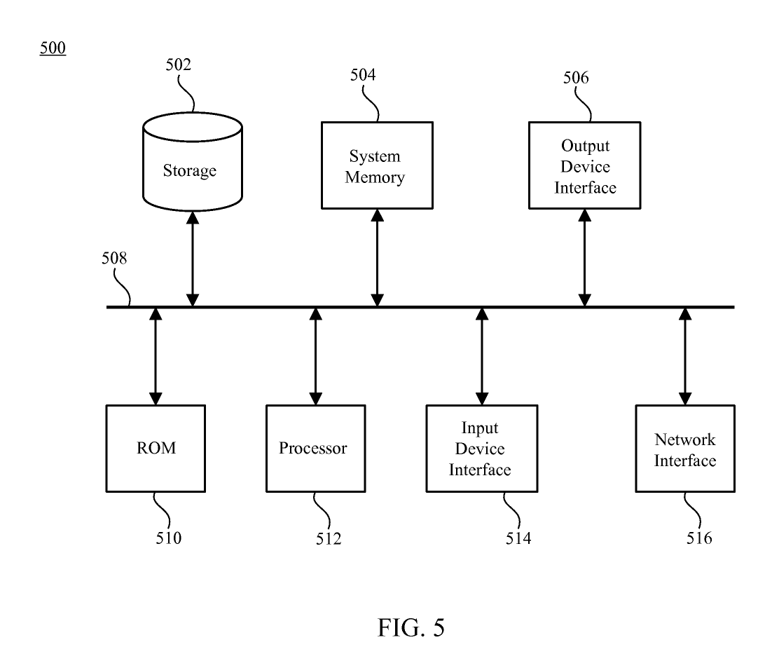

FIG. 5 conceptually illustrates electronic system 500 with which any implementations of the subject technology are implemented. Electronic system 500, for example, can be a desktop computer, a laptop computer, a tablet computer, a server, a switch, a router, a base station, a receiver, a personal digital assistant (PDA), a portable gaming device, a printer, any device that may be used for establishing in-band connections using out-of-band connections, or generally any electronic device that transmits signals over a network. Such an electronic system includes various types of computer readable media and interfaces for various other types of computer readable media. Electronic system 500 includes bus 508, processing unit(s) 512, system memory 504, read-only memory (ROM) 510, permanent storage device 502, input device interface 514, output device interface 506, and network interface 516, or subsets and variations thereof

Bus 508 collectively represents all system, peripheral, and chipset buses that communicatively connect the numerous internal devices of electronic system 500. In one or more implementations, bus 508 communicatively connects processing unit(s) 512 with ROM 510, system memory 504, and permanent storage device 502. From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. One or more implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as random access memory. System memory 504 stores any of the instructions and data that processing unit(s) 512 needs at runtime. In one or more implementations, the processes of the subject disclosure are stored in system memory 504, permanent storage device 502, and/or ROM 510. From these various memory units, processing unit(s) 512 retrieves instructions to execute and data to process in order to execute the processes of one or more implementations.

Bus 508 also connects to input and output device interfaces 514 and 506. Input device interface 514 enables a user to communicate information and select commands to the electronic system. Input devices used with input device interface 514 include, for example, alphanumeric keyboards and pointing devices (also called “cursor control devices”). Output device interface 506 enables, for example, the display of images generated by electronic system 500. Output devices used with output device interface 506 include, for example, display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 5, bus 508 also couples electronic system 500 to a network (not shown) through network interface 516. In this manner, the computer can be a part of a peer-to-peer network or a network of computers (such as a local area network (“LAN”), a wide area network (“WAN”), or an Intranet, or a network of networks, such as the Internet. Any or all components of electronic system 500 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more implementations, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more implementations, the computer readable media is non-transitory computer readable media, computer readable storage media, or non-transitory computer readable storage media.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) or performed simultaneously all without departing from the scope of the subject technology.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to analyze and control an operation or a component may also mean the processor being programmed to analyze and control the operation or the processor being operable to analyze and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A system for establishing an in-band connection using an out-of-band connection, the system comprising:
a handshake module configured to communicate, by a first electronic device with a second electronic device, connection setup information over a first connection;
a security module configured to select a security scheme based on the communicated connection setup information;
a role module configured to determine a communication role of the first electronic device and a communication role of the second electronic device based on the communicated connection setup information; and
a connection module configured to facilitate establishing a second connection between the first electronic device and the second electronic device based on the selected security scheme, the communication role of the first electronic device, and the communication role of the second electronic device, the second connection being different from the first connection.

2. The system of claim 1, wherein the handshake module is configured to engage, by the first electronic device, in a first connection handshake with the second electronic device over the first connection, and wherein a completion time of the first connection handshake over the first connection is less than a completion time of a second connection handshake, between the first electronic device and the second electronic device, over the second connection.

3. The system of claim 2, wherein the first connection handshake comprises:
detecting the second electronic device;
the communicating the connection setup information;
the selecting the security scheme; and
the determining the communication role of the first electronic device and the communication role of the second electronic device.

4. The system of claim 2, wherein the second connection handshake comprises:
detecting the second electronic device;
communicating, by the first electronic device with the second electronic device, second connection setup information;
selecting a second security scheme based on the second connection setup information and on user input;
determining a second communication role of the first electronic device and a second communication role of the second electronic device based on the second connection setup information, the determining the second communication role of the first electronic device and the second communication role of the second electronic device comprising negotiating, by the first electronic device with the second electronic device, the second communication role of the first electronic device and the second communication role of the second electronic device; and
scanning a plurality of channels between the first electronic device and the second electronic device.

5. The system of claim 1, wherein the first connection is at least one of a near-field communication connection and a Wi-Fi proximity connection, and wherein the second connection is a Wi-Fi direct connection.

6. The system of claim 1, wherein the connection setup information comprises at least one of an address of the first electronic device, an address of the second electronic device, the communication role of the first electronic device, the communication role of the second electronic device, a status of the first electronic device, a status of the second electronic device, a security scheme supported by the first electronic device, a security scheme supported by the second electronic device, power source information of the first electronic device, power source information of the second electronic device, wireless capability information of the first electronic device, wireless capability information of the second electronic device, enforced frequency information of the first electronic device, enforced frequency information of the second electronic device, a communication service supported by the first electronic device, a communication service supported by the second electronic device, an identification of the first electronic device, an identification of the second electronic device, an intent value to become group owner of the first electronic device, an intent value to become group owner of the second electronic device, channel information, a password, a random-generated personal identification number, a shared key, and one or more concurrency flags.

7. The system of claim 1, wherein the security scheme comprises at least one of a push-button scheme, a predetermined personal identification number (PIN) scheme, and a random PIN scheme.

8. The system of claim 1, wherein the determining the communication role of the first electronic device and the communication role of the second electronic device comprises determining whether the first electronic device and the second electronic device are already operating as group owners.

9. The system of claim 8, wherein the determining the communication role of the first electronic device and the communication role of the second electronic device further comprises selecting the first electronic device or the second electronic device as group owner if (i) neither the first electronic device nor the second electronic device is already operating as group owner or (ii) both the first electronic device and the second electronic device are already operating as group owners.

10. The system of claim 9, wherein the selecting the first electronic device or the second electronic device as group owner comprises:
comparing a parameter of the first electronic device to a parameter of the second electronic device; and
selecting the first electronic device or the second electronic device as group owner based on the comparison.

11. The system of claim 10, wherein the parameter of the first electronic device and the parameter of the second electronic device each comprises at least one of an address, a power source, an amount of power, and an intent value to become group owner.

12. The system of claim 9, wherein, if the first electronic device is selected as group owner, the facilitating establishing the second connection comprises detecting a connection request for the second connection from the second electronic device.

13. The system of claim 9, wherein, if the second electronic device is selected as group owner, the facilitating establishing the second connection comprises initiating the second connection using the selected security scheme.

14. The system of claim 8, wherein, if the first electronic device is already operating as group owner and the second electronic device is not already operating as group owner, the facilitating establishing the second connection comprises detecting a connection request for the second connection from the second electronic device.

15. The system of claim 8, wherein, if the first electronic device is not already operating as group owner and the second electronic device is already operating as group owner, the facilitating establishing the second connection comprises initiating the second connection using the selected security scheme.

16. A method for establishing an in-band connection using an out-of-band connection, the method comprising:
communicating, by a first electronic device with a second electronic device, connection setup information over a first connection;
selecting a security scheme based on the communicated connection setup information;
determining a communication role of the first electronic device and a communication role of the second electronic device based on the communicated connection setup information; and
facilitating establishing a second connection between the first electronic device and the second electronic device based on the selected security scheme, the communication role of the first electronic device, and the communication role of the second electronic device, the second connection being different from the first connection.

17. The method of claim 16, further comprising engaging, by the first electronic device, in a first connection handshake with the second electronic device over the first connection, and wherein a completion time of the first connection handshake over the first connection is less than a completion time of a second connection handshake, between the first electronic device and the second electronic device, over the second connection.

18. The method of claim 16, wherein the determining the communication role of the first electronic device and the communication role of the second electronic device comprises determining whether the first electronic device and the second electronic device are already operating as group owners.

19. A machine-readable medium encoded with executable instructions for a method of establishing an in-band connection using an out-of-band connection, the method comprising:
detecting, by a first electronic device, a second electronic device;
communicating, by the first electronic device with the second electronic device, connection setup information over at least one of a near-field communication (NFC) connection and a Wi-Fi proximity connection in response to the detection of the second electronic device;
selecting a security scheme based on the communicated connection setup information, the security scheme comprising at least one of a push-button scheme, a predetermined personal identification number (PIN) scheme, and a random PIN scheme;
determining a communication role of the first electronic device and a communication role of the second electronic device based on the communicated connection setup information; and
facilitating establishing a Wi-Fi direct connection between the first electronic device and the second electronic device based on the selected security scheme, the communication role of the first electronic device, and the communication role of the second electronic device.

20. The machine-readable medium of claim 19, wherein the method further comprises selecting an operating channel of the Wi-Fi direct connection without scanning a plurality of channels between the first electronic device and the second electronic device.
